(19) United States
(12) Patent Application Publication
(10) Pub. No.: US 2001/0054958 A1
(43) Pub. Date: Dec. 27, 2001

(54) Shoplifting monitoring apparatus

(75) Inventor: Toichiro Matsuo, Arao-shi (JP)

Correspondence Address: ARENT FOX KINTNER PLOTKIN & KAHN, PLLC, 1050 Connecticut Avenue, N.W., Suite 600, Washington, DC, 20036-5339, US

(73) Assignee: MATSUO SANGYO KABUSHIKI KAISHA

(21) Appl. No.: 09/780,473

(22) Filed: Feb. 12, 2001

(30) Foreign Application Priority Data
Jun. 23, 2000 (JP) 2000-189679

(51) Int. Cl. G08B 21/00

(52) U.S. Cl. 340/568.1; 340/540

(57) ABSTRACT

A shoplifting monitoring apparatus comprising a casing having an article attachment surface to be attached to an article; a switch at least partly accommodated in the casing, having a movable piece biased to project outward from the article attachment surface of the casing, and having a contact adapted to become closed when the movable piece is pushed toward an inside of the casing and to become open when the movable piece is projected outward from the casing; a first conductive member provided at the article attachment surface of the casing; a second conductive member provided at the article attachment surface of the casing, and remote from the first conductive member; a conductive film to be provided at the article attachment surface of the casing and to be in contact with each of the first and second conductive members; and an alarm device; wherein an electric contact is formed by the conductive film and the first and second conductive members, and the alarm device issues an alarm when the contact of the switch is open and/or when an electrically connected state between the first and second conductive members is open.

This invention is based on patent application Ser. No. 2000-189679 Pat. filed in Japan, the contents of which are hereby incorporated by reference.

### BACKGROUND OF THE INVENTION

1. Field of the Invention

The present invention relates to a shoplifting monitoring apparatus for preventing or deterring an article or goods from being shoplifted.

2. Description of Related Art

A wide variety of shoplifting monitoring apparatus have been proposed for preventing or deterring an article or goods, e.g., on display in a shop, from being shoplifted.

For example, such a shoplifting monitoring apparatus, having an attachment unit to be attached to the article, has been proposed in which the attachment unit has a switch and a casing accommodating the switch, and the switch has a contact adapted to open or close in accordance with a position of a movable piece.

In this shoplifting monitoring apparatus, an alarm is issued according to an open-closed state of the contact in the switch.

The movable piece can move between the inside and the outside of the casing, and is biased to project toward outside of the casing when no external force is acting to the movable piece. The open-closed state of the contact of the switch is changed in accordance with the position or movement of the movable piece. The contact of the switch is closed when the movable piece is retracted in the casing. The contact of the switch is open when the movable piece projects outward from the casing by the biasing force.

The attachment unit is attached to the article with, e.g., a double-sided adhesive tape so that the movable piece is retracted into the casing, namely the contact of the switch is closed. When the attachment unit is removed from the article by theft or shoplifting of the article, the movable piece normally projects outward from the casing due to the biasing force, whereby the contact of the switch becomes open to trigger the alarm.

However, in the shoplifting monitoring apparatus of above type, the alarm is not issued if the attachment unit is removed from the article after the movable piece is held not to project outside of the casing by inserting a thin plate such as a resin plate into a space between the article and the attachment unit attached thereto, and thereby after the contact of the switch is held not to become open. Consequently, if an article is shoplifted in this way with the malicious intent, it would be difficult for a shop assistant to find the shoplifting of the article, and to prevent pilferage of the article.

### SUMMARY OF THE INVENTION

An object of the present invention is to provide a shoplifting monitoring apparatus for preventing or deterring an article from being shoplifted, and more particularly, to provide the shoplifting monitoring apparatus which can issue the alarm for preventing or suppressing pilferage of the article even when someone attempts to detach the attachment unit from the article after holding the movable piece of the switch not to project outward from the casing by inserting the thin plate into the space between the article and the attachment unit attached thereto.

The invention provides a shoplifting monitoring apparatus comprising a casing having an article attachment surface to be attached to an article; a switch at least partly accommodated in the casing, having a movable piece biased to project outward from the article attachment surface of the casing, and having a contact adapted to become closed when the movable piece is pushed toward an inside of the casing and to become open when the movable piece is projected outward from the casing; a first conductive member provided at the article attachment surface of the casing; a second conductive member provided at the article attachment surface of the casing, and remote from the first conductive member; a conductive film to be provided at the article attachment surface of the casing and to be in contact with each of the first and second conductive members; and an alarm device; wherein an electric contact is formed by the conductive film and the first and second conductive members, and the alarm device issues an alarm when the contact of the switch is open and/or when an electrically connected state between the first and second conductive members is open.

The foregoing and other objects, features, aspects and advantages of the present invention will become more apparent from the following detailed description and the accompanying drawings.

### BRIEF DESCRIPTION OF THE DRAWINGS

FIG. 1 is a schematic view showing the structure of an example of the shoplifting monitoring apparatus according to the invention.

FIG. 2 is a schematic perspective view showing the interior of the casing of the attachment unit.

FIG. 3 is a schematic plan view of the attachment unit at the article attachment surface of the casing.

FIG. 4(A), FIG. 4(B) and FIG. 4(C) are schematic section views of the attachment unit taken along 4A-4A line, 4B-4B line and 4C-4C line, respectively, of FIG. 3.

FIG. 5(A) and FIG. 5(B) are schematic section views of the attachment unit taken along 5A-5A line and 5B-5B line, respectively, of FIG. 3.

FIG. 6(A) and FIG. 6(B) show the attachment units before and after attaching the conductive film and double-sided adhesive tape to the casing of the attachment unit, respectively.

FIG. 7 shows an example of the electrical connection among the conductive film, conductive members and the switch in the attachment unit.

FIG. 8 shows circumstances when the thin plate is inserted into the space between the attachment unit and the article.

FIG. 9(A) shows another example of the arrangement of the conductive film and the conductive members in the attachment unit, and FIG. 9(B) shows an example of the electrical connection among the conductive film, the conductive members and the switch shown in FIG. 9(A).

FIG. 10(A) shows still another example of the arrangement of the conductive film and the conductive members in the attachment unit, and FIG. 10(B) shows an example of the electrical connection among the conductive film, conductive members and the switch shown in FIG. 10(A).

FIG. 11 shows an example of a circuit diagram of the alarm device.

### DESCRIPTION OF THE PREFERRED EMBODIMENTS

(1) The shoplifting monitoring apparatus of the invention has a casing, a switch, a first conductive member, a second conductive member, a conductive film and an alarm device.

The casing, switch, first conductive member, second conductive member and conductive film are provided as a unit to be attached to an article which is monitored to prevent the theft or shoplifting of the article. This unit is referred to as “article-attachment unit”, or merely as “attachment unit” hereinafter.

The casing of this attachment unit is to be attached at its predetermined surface to the article. The surface, to be attached to the article, of the casing is referred to as “article attachment surface” hereinafter. The casing may be attached to the article, e. g. , with a double-sided adhesive tape or the like. The casing (cover casing) may be, e.g., hollow to accommodate the switch and others therein.

The switch is provided for detecting whether the attachment unit is attached to the article or not. At least a part of the switch is accommodated in the casing. The switch has a movable piece, and also has a contact which opens or closes in accordance with the position or movement of the movable piece. The movable piece is movable from the inside to the outside, or vice versa, of the casing. For permitting the movement of the movable piece as described above, the casing may have, for example, an aperture through which the movable piece can move between the inside and outside of the casing. The movable piece is biased to project outward from the article attachment surface of the casing. At least a part of the movable piece is projected toward the outside of the casing by the biasing force. When the movable piece is projected outward from the casing by the biasing force, the contact of the switch is in the open state. When the movable piece is pushed toward the inside of the casing against the basing force, in other words, when the movable piece is retracted in the inside of the casing against the basing force, the contact of the switch is in the closed state.

Accordingly, when the casing (or attachment unit) is attached to the article so that the movable piece is pushed into the casing, the contact of the switch becomes closed. When the attachment unit is separated or removed from the article after attaching the attachment unit to the article as described above, the movable piece projects from the casing due to the biasing force in so far as an external force, against the biasing force pushing the movable piece outward from the casing, is not exerted to the movable piece. Thereby, the contact of the switch becomes open. Accordingly, in so far as said external force is not exerted, it can be detected by the switch whether the attachment unit is attached to the article or not.

The shoplifting monitoring apparatus of the invention has not only the contact of the switch which is open or closed as described above but also a contact formed, as stated below, by the first conductive member, the second conductive member and the conductive film.

The first conductive member and the second conductive member are both provided at the article attachment surface of the casing. The first conductive member is at least partly exposed at the article attachment surface of the casing, and the second conductive member is at least partly exposed at the article attachment surface of the casing. The surface, at which the first and second conductive members are exposed, of the casing is attached to the article, and therefore a difference in level is preferably minimized between the article attachment surface of the casing and the surfaces, to be attached to the article, of the first and second conductive members. The first and second conductive members are remote from each other, and therefore are not directly electrically connected to each other.

The conductive film, as well as the first and second conductive members, is to be arranged at the article attachment surface of the casing. When the attachment unit is attached to the article, the conductive film is to be arranged at a position between the article attachment surface of the casing and the article surface. Stated more specifically, the conductive film is to be arranged at a position between the article surface and the surfaces, exposed at the article attachment surface of the casing, of the first and second conductive members.

The conductive film is to be in contact with each of the first and second conductive members. For example, the conductive film may be fixed to one surface of the double-sided adhesive tape, and the double-sided adhesive tape may be attached to the article attachment surface of the casing, whereby the conductive film can be in contact with both the first and second conductive members.

The first and second conductive members are to be electrically connected to each other by bringing the conductive film into contact with each of the first and second conductive members. Accordingly, when the conductive film is in contact with both the first and second conductive members, the first and second conductive members are electrically connected to each other, and an electrically connected state between the first and second conductive members is closed. Reversely, when the conductive film is not in contact with at least one of the first and second conductive members, the electrically connected state between the first and second conductive members is open. In this way, the electric contact is formed by the conductive film and the first and second conductive members. The conductive film performs the similar function as the movable piece of the switch.

The first conductive member constituting the contact together with the second conductive member may be composed of a plurality of conductive members. In this case, the plural conductive members functioning as the first conductive member may be electrically connected to each other by a lead wire or the like. Likewise the second conductive member constituting the contact together with the first conductive member may be composed of a plurality of conductive members. In this case, the plural conductive members functioning as the second conductive member may be electrically connected to each other with a lead wire or the like.

The alarm device issues an alarm based on the open-closed state of the switch contact and the open-closed state of the contact formed by the conductive film and the first and second conductive members. The alarm device gives the alarm when the switch contact is open and/or when the contact formed by the conductive film and others is open. In other words, the alarm device gives the alarm when the switch contact is open and/or when the electrically connected state between the first and second conductive members is open. The alarm device may warn or signal by means of, e.g., a sound, light or others.

For putting the shoplifting monitoring apparatus of the invention to use, the shoplifting monitoring apparatus is preset to an initial state as follows. The attachment unit is attached at its predetermined surface (i.e., the article attachment surface of the casing) to the article, and thereby the movable piece of the switch is pushed into the casing to close the switch contact. Also, the conductive film is brought into contact with both the first and second conductive members, and is arranged between the article and the first and second conductive members.

After presetting the shoplifting monitoring apparatus to the initial state described above, if the attachment unit is removed from the article incidentally or intentionally, the movable piece of the switch normally projects outside of the casing due to the biasing force, and thereby the switch contact becomes open and the alarm device gives the alarm. Therefore the theft or shoplifting of the article can be suppressed.

In the initial state, the movable piece of the switch is pushed into the inner side of the casing, and the switch contact is closed as described above. When the attachment unit is removed from the article, as described above, the movable piece of the switch normally projects outward from the casing due to the biasing force and the switch contact opens. Therefore the removal (or separation) of the attachment unit from the article is detected by the switch so that the alarm device can give the alarm.

However, if the following malicious act is conducted, the separation of the attachment unit from the article can not be detected by the switch. It is impossible to detect the separation of the attachment unit from the article by the switch, for example, after the movable piece of the switch is held not to project outward from the casing, in other words, after the switch contact is held not to become open by inserting a thin plate into the space between the article and the attachment unit, even when the attachment unit is removed from the article.

However, according to the shoplifting monitoring apparatus of the invention, the insertion of the thin plate into the space between the article and the attachment unit can be detected, as described below, by the contact formed by the conductive film and the first and second conductive members. Based on the detected information with the contact formed by the conductive film and others, the alarm is issued from the alarm device.

The conductive film is provided, as described above, in the space between the article attachment surface of the casing and the article surface, i.e., the space into which the thin plate is inserted to prevent the outward projection of the movable piece from the casing. The conductive film may be rolled, smashed or broken by the thin film inserted into such the space so that the electrical contact would be disengaged between the conductive film and the first and/or second conductive members. Thereby, the electrically connected state between the first and second conductive members becomes open, namely the contact formed by the conductive film and the first and second conductive members becomes open, as a result, the alarm device gives the alarm to prevent the theft or shoplifting of the article.

In the shoplifting monitoring apparatus of the invention, the insertion of the thin plate or the like is detected by such an act that the thin plate or the like inserted into the space breaks the electrical connection between the first and second conductive members linked by the conductive film.

Accordingly, in the shoplifting monitoring apparatus of the present invention, desirably the conductive film is merely in contact with, but not fixed to, the first and second conductive members in order that the conductive film is liable to deform due to the thin plate inserted into the space, and more particularly, in order that the electrically connected state between the conductive film and the first and/or second conductive members is liable to become open by the insertion of the thin plate.

Preferably the conductive film is provided on an invasion route of the thin plate or the like, i.e., an access route of the thin plate or the like to prevent the outward projection of the movable piece from the casing.

The conductive film may be provided on at least one access route. However, it is preferable to provide the conductive film on all or substantially all of access routes. For example, the conductive film may be provided at the article attachment surface of the casing to completely or almost completely enclose the surroundings of an area where the movable piece may project at the casing surface. In this way, the conductive film can be arranged on all or substantially all of the access routes.

In order to provide the conductive film on all or substantially all of the access routes or other purpose(s), a plurality of contacts formed by the conductive film and the first and second conductive members may be provided in the attachment unit. Stated more specifically, the attachment unit may have two or more contacts each formed by a group of the conductive film and the first and second conductive members. If a plurality of contacts are employed, the single conductive member (i.e., first or second conductive member) may be used commonly in two or more contacts. Likewise, the single conductive film may be used commonly in two or more contacts.

The movable piece of the switch may be adapted to move between the inside and the outside of the casing, for example, in an area substantially in the center of the article attachment surface of the casing. In other words, the movable piece of the switch may be adapted to project outwardly from the casing due to the biasing force, for example, in an area substantially in the center of the article attachment surface of the casing. According to this, the conductive film can be provided to completely or almost completely enclose the surroundings of the area on the casing surface where the movable piece may project at the casing surface. Also, a distance for access to the movable piece can be increased, which makes prevention of the outward projection of the movable piece by the thin plate more difficult, compared with the case where the movable piece is provided at a terminal area on the article attachment surface of the casing.

The information detected by the switch and the contact formed by the conductive film and others may be sent to the alarm device, for example, by an electric cable having at least two lead wires. The contact of the switch and the contact formed by the conductive film and the first and second conductive members may be connected e.g. in series. According to this, only two lead wires are required for the cable in sending the detected information to the alarm device. Therefore, the costs of the shoplifting monitoring apparatus can be lowered.

The alarm device may be provided with a plurality of alarming elements, and may give alarms at two or more positions.

The alarming element may be disposed in the attachment unit (e.g., inside the casing). The provision of the alarming element in the attachment unit makes it possible to make the shoplifter aware of the discovery of shoplifting, and also makes it possible to raise the alarm at a position on or extremely near the hand of the shoplifter so that the theft of the articles can be more likely and more effectively prevented or suppressed than when the alarm is issued at a position remote from the shoplifter.

The shoplifting monitoring apparatus of the invention may have two or more attachment units each, as described above, including the casing, switch, first and second conductive members and conductive film. In this case, the alarm device may be adapted to raise the alarm, for example, when the contact of the switch in at least one attachment unit is open and/or when the electrically connected state is open between the first and second conductive members in at least one attachment unit. (2) Embodiments of the present invention will be described below with reference to the accompanying drawings.

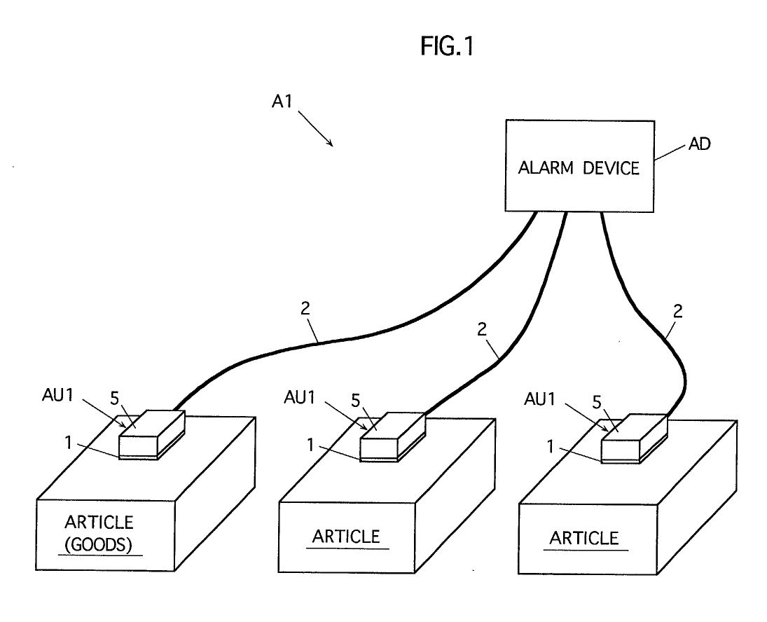

FIG. 1 is a schematic view showing a structure of an example of the shoplifting monitoring apparatus according to the invention.

A shoplifting monitoring apparatus A1 shown in FIG. 1 has an alarm device AD and an article-attachment unit AU1. In this embodiment, the shoplifting monitoring apparatus A1 is provided with three attachment units AU1.

The attachment unit AU1 is to be attached to an article to be monitored for preventing the theft or shoplifting of the article. The attachment unit AU1 of this embodiment is fixed with a double-sided adhesive tape 1 to the monitoring target article.

The alarm device AD issues an alarm according to information detected by the attachment unit AU1. Stated more specifically, the alarm device AD raises the alarm, for example, when the attachment unit AU1 is detached from the article. The information detected by the attachment unit AU1 is sent to the alarm device AD by a cord 2 extending from the attachment unit AU1.

The attachment unit AU1 has a switch (not shown in FIG. 1) for detecting whether the attachment unit AU1 is attached to the article or not. The switch is accommodated in a casing 5.

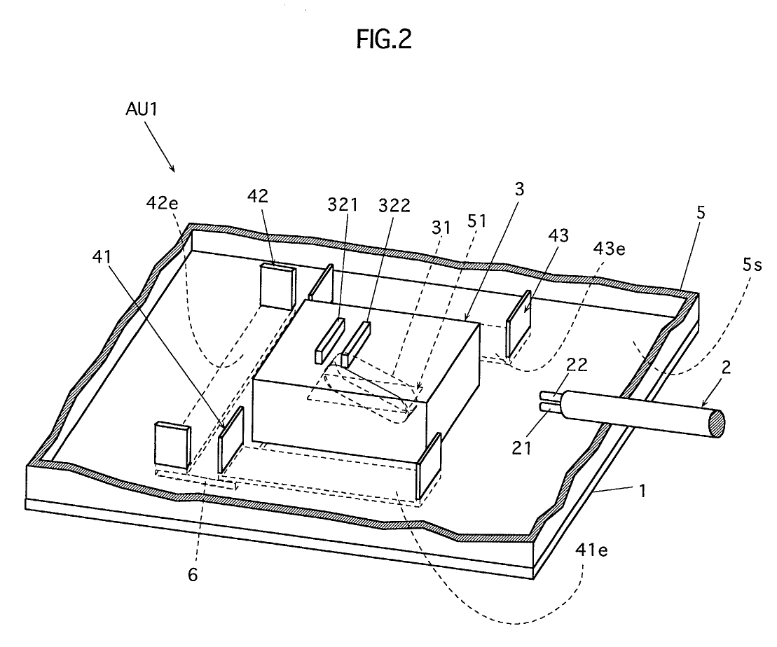

FIG. 2 is a schematic perspective view showing the interior of the casing 5 of the attachment unit AU1. The casing 5 is partly taken away in FIG. 2.

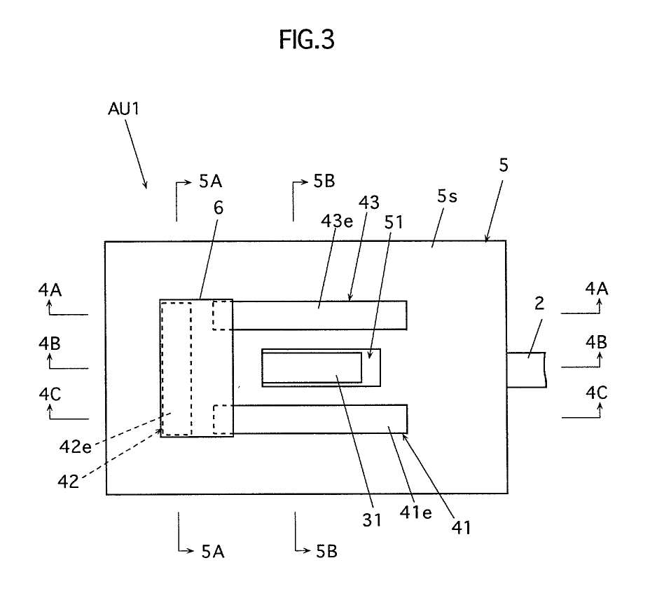

FIG. 3 is a schematic plan view of the attachment unit AU1 at an article attachment surface 5s of the casing 5. The double-sided adhesive tape 1 is not shown in FIG. 3 for ease of understanding.

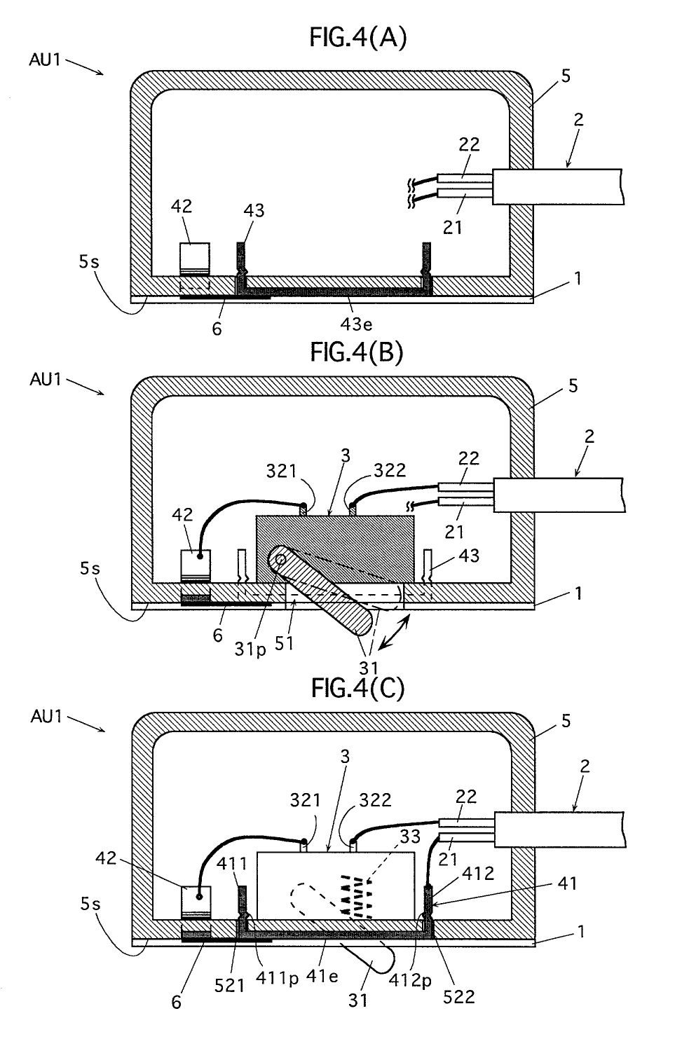

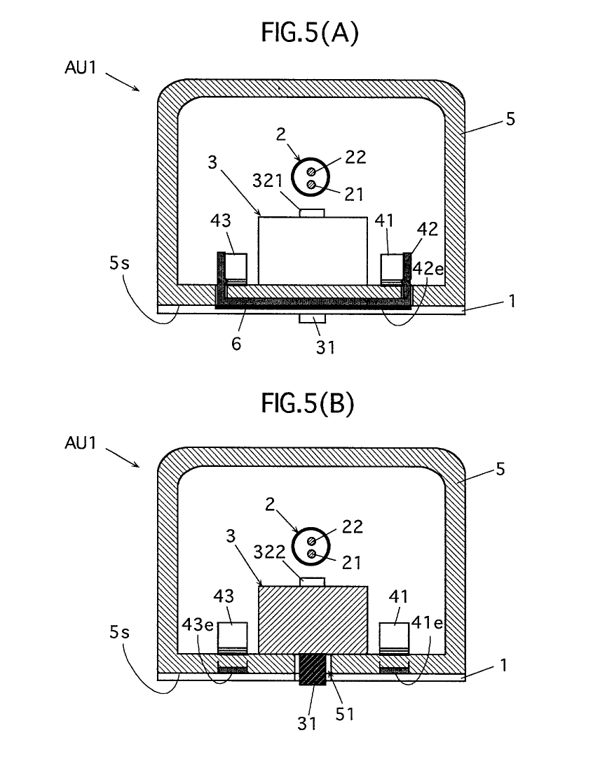

FIG. 4(A), FIG. 4(B) and FIG. 4(C) are schematic section views of the attachment unit AU1 taken along 4A-4A line, 4B-4B line and 4C-4C line, respectively, of FIG. 3. FIG. 5(A) and FIG. 5(B) are schematic section views of the attachment unit AU1 taken along 5A-5A line and 5B-5B line, respectively, of FIG. 3.

The switch 3 provided in the casing 5 has a movable piece 31. The movable piece 31 is movable between the inside and the outside of the casing 5 through an aperture 51 formed at the article attachment surface 5s of the casing 5 (see FIG. 4 (B)). The movable piece 31, in this embodiment, is pivotable around a fulcrum 31p for movement inside and outside the casing 5. The movable piece 31 is biased by a spring 33 to project outward from the casing 5 and can project outward from the article attachment surface 5s of the casing 5 by the biasing force. The movable piece 31 projects outward from the casing 5 substantially in the center of the article attachment surface 5s of the casing 5.

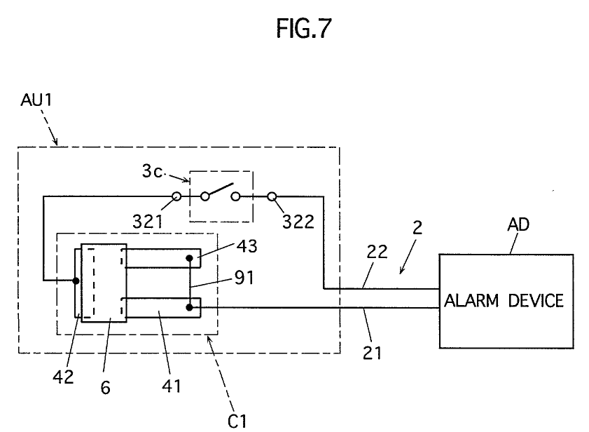

An open-closed state of a contact 3c of the switch 3 (see FIG. 7) is mechanically associated with a position or movement of the movable piece 31. The contact 3c of the switch 3 is open when the movable piece 31 projects outside from the casing 5, whereas the contact 3c of the switch 3 is closed when the movable piece 31 is retracted in the casing 5.

Two terminals of the contact 3c of the switch 3 are connected to outer leads 321 and 322, respectively.

Three conductive members 41, 42, 43 are arranged as described below at the article attachment surface 5s of the casing 5.

The conductive member 41 is U-shaped in the section as shown in FIG. 4(C) and others. Two end portions 411, 412 of the conductive member 41 are fitted from the outside of the casing 5 into two apertures 521, 522 of the casing 5, respectively, so that a surface 41e of a central portion of the conductive member 41 is exposed at the article attachment surface 5s of the casing 5. In this embodiment, the casing 5 has a recess for fitting the conductive member 41 therein so that the exposed surface 41e of the conductive member 41 is at the same level as the surface 5s of the casing 5, namely so that the conductive member 41 does not hinder the attachment of the attachment unit AU1 to the article. If the conductive member 41 is sufficiently thin, there is no necessity for the casing 5 to have such recess. The end portions 411, 412 of the conductive member 41 have projections 411p, 412p at inwardly projected portions in the casing 5, respectively, so that the conductive member 41 is engaged to the casing 5 by these projections.

The conductive members 42, 43 are U-shaped in the section like the conductive member 41. Surfaces 42e, 43e of the conductive members 42, 43 are exposed outside of the article attachment surface 5s of the casing 5 in the same manner of the conductive member 41.

The exposed surfaces 41e, 42e, 43e of the conductive members 41, 42, 43 are provided to surround an area in which the movable piece 31 of the switch 3 is movable inside and outside the casing 5. The conductive members 41, 42, 43 are arranged at positions away from each other, and therefore are not directly electrically connected to each other.

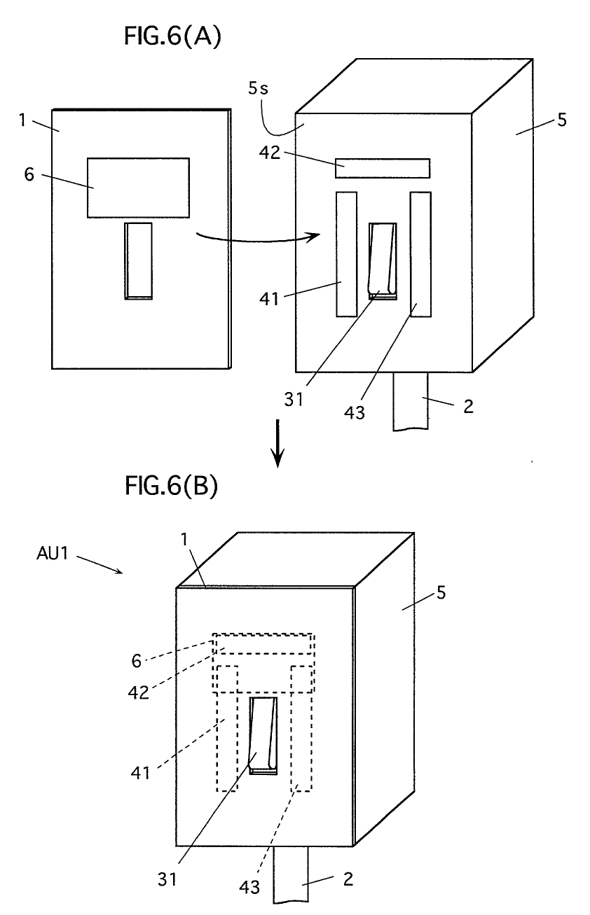

A conductive film 6 is provided on the article attachment surface 5s of the casing 5 as described below. The conductive film 6 is in contact with the conductive member surfaces 41e, 42e, 43e exposed at the surface 5s of the casing 5. In this embodiment, the conductive film 6 is attached to one surface of the double-sided adhesive tape 1, and then the tape 1 is fixed to the surface 5s of the casing 5 to bring the conductive film 6 into contact with the conductive members 41, 42 and 43 as shown in FIG. 6(A) and FIG. 6(B). The conductive film 6 is not adhered to the conductive members 41, 42 and 43. The conductive members 41, 42, 43 are electrically connected to each other by the conductive film 6.

An electrical connection among the contact of the switch 3, the conductive members and others in the attachment unit AU1 is shown in FIG. 7.

The conductive members 41 and 43 are electrically connected to each other by a lead wire 91 in the casing 5. The conductive members 41 and 43 are electrically connected to the conductive member 42 by the conductive film 6 as described above.

In the shoplifting monitoring apparatus A1 of the invention, a contact C1 is formed by the conductive film 6 and conductive members 41, 42, 43. In the contact C1, the electrical connected state between the conductive members 41, 43 and the conductive member 42 is open or closed as follows.

When the conductive film 6 is in contact with all of the conductive members 41, 42 and 43, the conductive members 41, 43 are electrically connected to the conductive member 42, namely the contact C1 is closed. When the conductive film 6 is not in contact with the conductive member 42, the conductive members 41, 43 are not electrically connected to the conductive member 42, namely the contact C1 is open. When the conductive film 6 is in contact with neither the conductive members 41 nor 43, the conductive members 41 and 43 are not electrically connected to the conductive member 42, namely the contact C1 is open.

The contact C1 is a normally-closed contact (break contact), which is closed in a normal state wherein the conductive film 6 is in contact with all of the conductive members 41, 42 and 43.

The contact C1, which is opened or closed as described above, is connected in series to the contact 3c of the switch 3. The ends of the series-connected contacts C1 and 3c are linked to lead wires 21 and 22 of a cable 2, respectively. The contact information of the contacts C1 and 3c in the attachment unit AU1 is sent to the alarm device AD by the cable 2 having the lead wires 21 and 22. The contact information is input into the alarm device AD from each of the three attachment units AU1.

The alarm device AD is adapted to raise the alarm when at least one of contacts C1 and 3c in at least one of attachment units AU1 is open.

Described below is how the shoplifting monitoring apparatus A1 of the invention is used.

Three attachment units AU1 are attached in the following manner to the monitoring target articles. The surface 5s, at which the conductive members and others are provided, of the casing 5 is attached to the article with the double-sided adhesive tape 1. By this attachment of the attachment unit AU1 to the article, the movable piece 31 of the switch 3 is retracted inwardly into the casing 5 by the article so that the contact 3c of the switch 3 is set to be closed. Also, the conductive film 6 in contact with all of the conductive members 41, 42, 43 is set to the position between the surface 5s of the casing 5 and the surface of the article. This state is called hereinafter “initial state”.

In the initial state, the contact 3c of the switch 3 in each attachment unit AU1 is closed, and the contact C1 formed by the conductive film 6 and others in each attachment unit AU1 is also closed. Accordingly, the alarm device does not raise the alarm.

When at least one attachment unit AU1 in the initial state is detached from the article, the alarm is issued from the alarm device AD as follows. The movable piece 31 of the switch 3 in the attachment unit AU1 detached from the article normally projects outside the casing 5 due to the biasing force of the spring 33. When the attachment unit AU1 is detached from the article, therefore the contact 3c of the switch 3 in that attachment unit AU1 normally becomes open. As a result, the alarm device AD raises the alarm. The alarm device AD warns or signals by means of a sound and light in this embodiment. The sound or light thus issued out can prevent or suppress the theft or shoplifting of the article.

In the shoplifting monitoring apparatus A1, as described above, the switch 3 is provided for detecting whether the attachment unit AU1 is attached to the monitoring target article or not, and the alarm device AD raises the alarm when the switch 3 detects the separation of the attachment unit AU1 from the article.

However, if the following malicious act is carried out, the separation of the attachment unit AU1 from the article can not be detected by the switch 3.

It is impossible to detect the separation of the attachment unit AU1 from the article by the switch 3 after the movable piece 31 of the switch 3 is held not to project outward from the casing 5, in other words, after the contact 3c of the switch 3 is held not to become open by inserting a thin plate to a space between the article and the attachment unit AU1, even when the attachment unit AU1 is removed from the article.

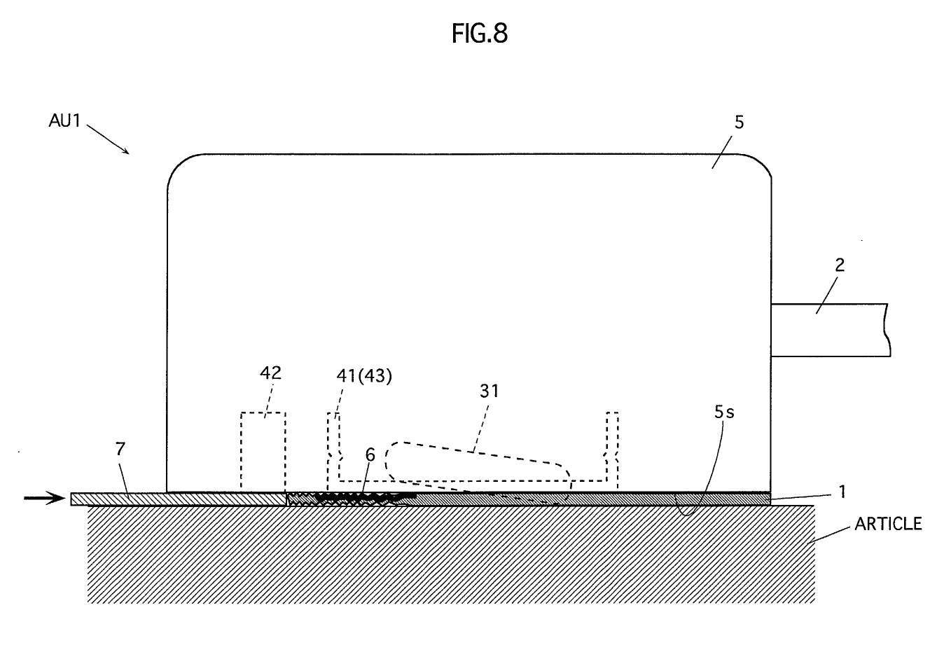

However, according to the shoplifting monitoring apparatus A1 of the invention, the insertion of the thin plate into the space between the article and the attachment unit AU1 can be detected in the following manner using the contact C1 formed by the conductive film 6 and others. This detecting manner is described below with reference to FIG. 8.

The conductive film 6 and the double-sided adhesive tape 1 are provided, as described above, in the space between the article attachment surface 5s of the casing 5 and the article surface into which the shoplifter may insert a thin plate 7 to prevent the outward projection of the movable piece 31 of the switch 3 from the casing 5.

The conductive film 6 may be rolled, smashed or broken by the insertion of the thin plate 7 into the space as shown in FIG. 8. Since the conductive film 6 is not adhered to the conductive members 41-43, such deformation of the conductive film 6 would be likely to occur due to the insertion of the thin plate 7. The deformation of the conductive film 6 would disengage the contact between the conductive film 6 and the conductive member 42, or between the conductive 6 and the conductive members 41, 43, so that the contact C1 formed by the conductive film 6 and others becomes open. Thereby the insertion of the thin plate 7 into the space can be detected. When the contact C1 becomes open, the alarm device AD gives the alarm as described above so that the theft or shoplifting of the article can be suppressed.

In this way, the shoplifting monitoring apparatus A1 of the invention can effectively counter against the above-mentioned malicious act.

In the shoplifting monitoring apparatus A1, the contact C1 formed by the conductive film 6 and others, provided for detecting insertion of the thin plate into the space between the attachment unit AU1 and the article, is the break contact (normally-closed contact) as described above. It may be possible to detect the insertion of the thin plate into the space by a make contact (normally-open contact) which is formed by a conductive film and conductive members. The break contact employed in the shoplifting monitoring apparatus A1 of the invention can more assuredly change the open-closed state of the contact by deformation of the conductive film, compared with the case where the make contact is employed. The insertion of the thin plate can be detected by the break contact more precisely, and therefore the theft or shoplifting of the article can be suppressed more effectively, compared with the case where the make contact is employed.

In the shoplifting monitoring apparatus A1, if the conductive film 6 and the tape 1 at the attachment unit AU1 are damaged by the thin plate 7 inserted into the space, the attachment unit AU1 can be re-used by a simple procedure of attaching to the unit surface a new piece of the tape 1 having the conductive film 6 adhered thereto, as shown in FIG. 6 (A) and FIG. 6 (B).

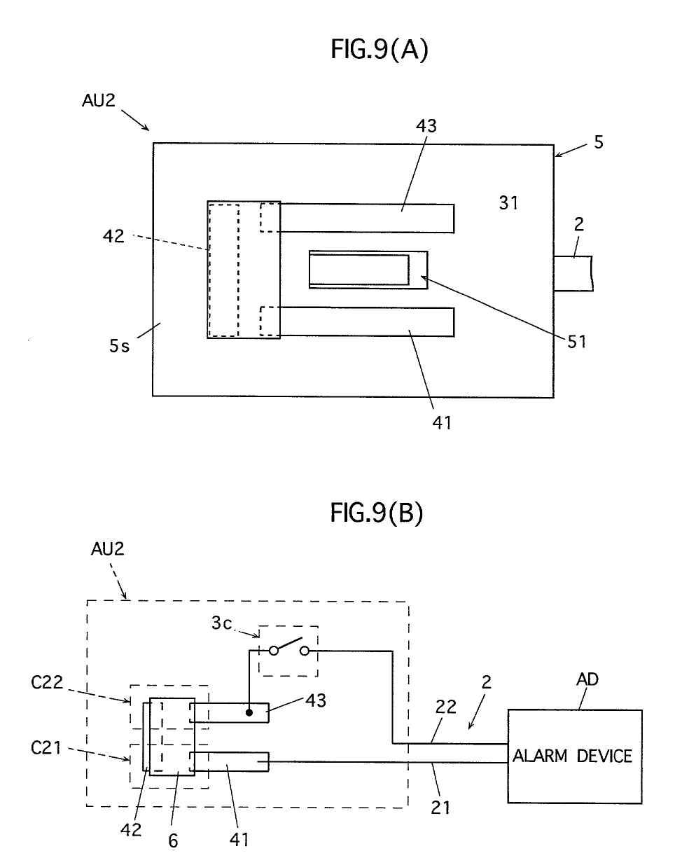

(3) Another example of the attachment unit is shown in FIGS. 9(A) and 9(B).

FIG. 9(A) shows the conductive film and the conductive members arranged at the article attachment surface of an attachment unit AU2. FIG. 9(B) shows the electrical connection among the conductive film, conductive members and contact 3c of the switch 3.

The attachment unit AU2 is to be attached to the article with the double-sided adhesive tape in the same manner of the attachment unit AU1. FIG. 9(A) omits illustration of the double-sided adhesive tape for ease of understanding. The arrangement of the conductive film 6 and conductive members 41, 42, 43 at the attachment unit AU2 is the same as that of the attachment unit AU1.

The attachment unit AU2 shown in FIGS. 9(A) and 9(B) is the same as the attachment unit AU1 of FIG. 3 except the following.

In the attachment unit AU2, the conductive members 41 and 43 are not directly electrically connected to each other. In the attachment unit AU2, a break contact C21 is formed by the conductive members 41, 42 and the conductive film 6, and a break contact C22 is formed by the conductive members 42, 43 and the conductive film 6. Accordingly, the conductive film 6 is used commonly in two contacts C21 and C22, and the conductive member 42 is also used commonly in two contacts C21 and C22. The contacts C21, C22 and the switch contact 3c are connected in this order in series.

In the attachment unit AU2, the contact C21 and/or C22 becomes open when the connection between the conductive film 6 and the conductive member 41 is disengaged, or when the connection between the conductive film 6 and the conductive member 42 is disengaged, or when the connection between the conductive film 6 and the conductive member 43 is disengaged. Consequently, the attachment unit AU2 can detect the insertion of the thin plate into the space more precisely than the attachment unit AU1 of FIG. 3.

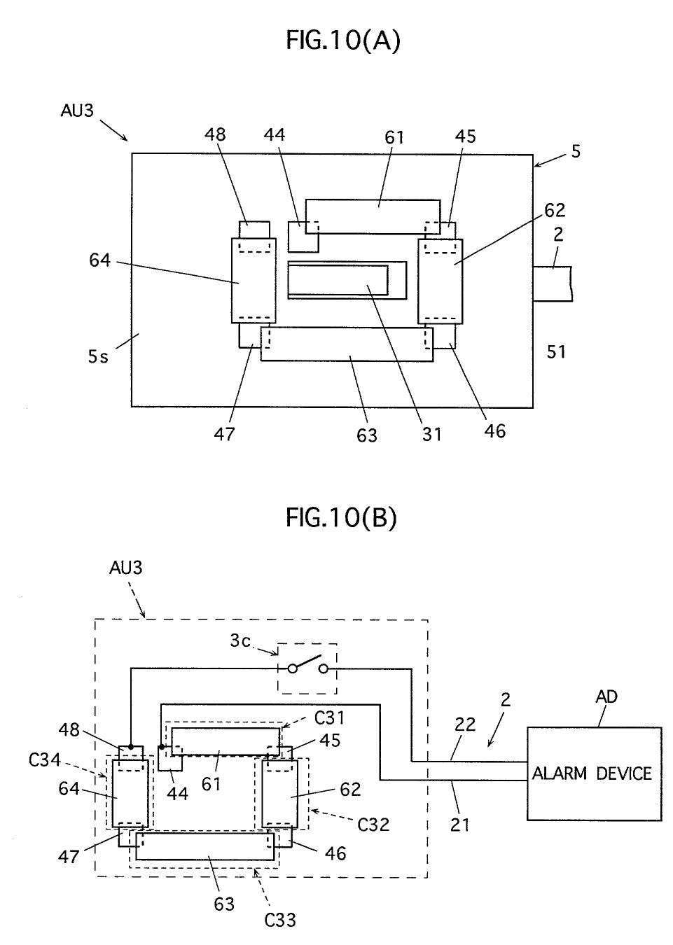

(4) A further example of the attachment unit is shown in FIGS. 10(A) and 10(B).

FIG. 10(A) shows the arrangement of the conductive film and the conductive members on the article attachment surface of an attachment unit AU3. FIG. 10(B) shows the electrical connection relation among the conductive film, conductive members and contact 3c of the switch 3.

The attachment unit AU3 is to be attached to the article with the double-sided adhesive tape in the same manner as the attachment unit AU1. FIG. 10(A) omits illustrating of the double-sided adhesive tape for ease of understanding.

The attachment unit AU3 of FIGS. 10(A) and 10(B) is the same as the attachment unit AU1 of FIG. 3 except the following.

In the attachment unit AU3, five conductive members 44-48 and four conductive films 61-64 are provided at the article attachment surface 5s of the casing 5. These conductive members 44-48 are exposed at the surface 5s of the casing 5 like the conductive members 41-43 of FIG. 3. The conductive members 44-48 and conductive films 61-64 substantial completely enclose the surroundings of the movable piece 31 at the article attachment surface 5s of the casing.

In the attachment unit AU3, four break contacts C31-C34 are formed as follows. The contact C31 is formed by the conductive members 44, 45 and the conductive film 61. The contact C32 is formed by the conductive members 45, 46 and the conductive film 62. The contact C33 is formed by the conductive members 46, 47 and the conductive film 63. The contact C34 is formed by the conductive members 47, 48 and the conductive film 64. The conductive member 45 is used commonly in the contacts C31 and C32. The conductive member 46 is used commonly in the contacts C32 and C33. The conductive member 47 is used commonly in the contacts C33 and C34.

The contacts C31, C32, C33, C34 and the switch contact 3c are connected in this order in series. Consequently when at least one of the contacts C31-C34 and the switch contact 3c is open, the alarm is raised.

In the attachment unit AU3, the conductive films 61-64 practically surround an area in which the movable piece 31 of the switch 3 moves between inside and outside the casing 5, and therefore the insertion of the thin plate into the space between the attachment unit AU3 and the article even from almost any direction can be detected. This means that the theft or shoplifting of the article can be so effectively suppressed.

(5) The alarming element, e.g. a buzzer, of the alarm device AD may be disposed at the attachment unit. If the alarming element is arranged at the attachment unit, e.g. inside the casing 5, the alarm is issued at the site of shoplifting. Stated more specifically, the alarm is raised at the hand of the shoplifter who has detached the attachment unit from the article, or at the hand of the shoplifter who has inserted the thin plate into the space between the article and the attachment unit. The theft or shoplifting of the article would be more likely to be prevented in the case of giving the alarm at the hand of the shoplifter, compared with the case where the alarm is raised in a position little apart from the shoplifter. The alarm would suggest the revelation of theft to the shoplifter.

Of course, the alarm may be given at a position (e.g. at a location remote from an area of displayed articles) where the shoplifter cannot be aware of the alarm.

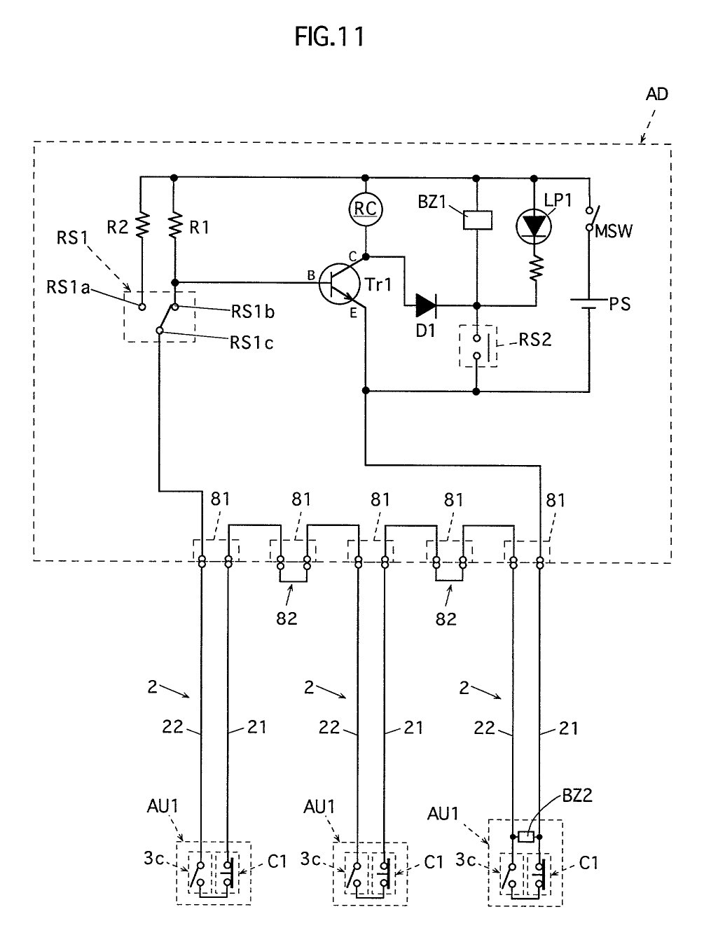

(6) FIG. 11 shows an example of a circuit diagram of the alarm device AD.

The alarm device AD of FIG. 11 has a buzzer BZ1 and a light-emitting diode lamp LP1 both serving as the alarming elements as well as a drive circuit for driving the alarming elements based on the information sent from the attachment unit.

In the embodiment of FIG. 11, the attachment unit AU1 is employed as the attachment unit. As described above, the attachment unit AU1 has the break contact C1 formed by the conductive film 6 and others as well as the switch contact 3c connected thereto in series (as shown in FIG. 3).

The alarm device AD has five female connectors 81 for connection of cords 2 extending from the attachment unit AU1 in this embodiment. Male connectors (not shown) which can fit to the female connectors 81 are provided at a terminal end, to be connected to the alarm device AD, of the cords 2, and therefore the cord 2 can be easily connected to the alarm device AD. A short-circuit cord 82 is connected to the connector 81 to which the cord 2 is not connected.

In the alarm device AD, an energized state of a relay coil RC and an on-off state of a transistor Tr1 are controlled based on the contact state of each the attachment unit AU1. According to this, the open-closed states of relay contacts RS1 and RS2 is controlled so that application of a voltage to the alarming element from a power source PS is controlled. The relay contacts RS1 and RS2 are opened or closed according to the energized state of the relay coil RC. The relay contact RS1 has three terminals RS1a, RS1b and RS1c. The terminal RS1c is a common terminal. A normally-open contact is formed by terminals RS1a and RS1c, and a normally-closed contact is formed by terminals RS1b and RS1c. The relay contact RS2 is a normally-open contact.

For putting the alarm device AD to use, each of the attachment units AU1 is attached to the article so that the switch contacts 3c are closed, and thereafter a main switch MSW is closed. In this initial state, the transistor Tr1 is off, the relay coil RC is not energized and the relay contact RS2 is open. Consequently a voltage is not applied from the power source PS to the buzzer BZ1 and lamp LP1 serving as the alarming elements, so that the alarm is not issued.

When the contact 3c and/or C1 in at least one attachment unit AU1 in the initial state becomes open, then the transistor Tr1 is on, the relay coil RC is energized, the relay contact RS2 is closed, and finally a voltage is applied to the buzzer BZ1 and lamp LP1. Thereby the buzzer BZ1 and the lamp LP1 are triggered to go off. When the relay coil RC is once energized, the buzzer BZ1 and lamp LP1 continue to issue the alarm even if the transistor Tr1 becomes off. This is because the energized state of the relay coil RC is maintained by its contact RS2 connected in series to the power source PS. The alarm device continues to issue the alarms until the main switch MSW is shut off.

Alarms are also raised, for example, when the lead wires 21 and/or 22 of the cable 2 in the initial state are cut off, or when the cable 2 in the initial state is pulled off from the connector 81 of the alarm device AD.

If the alarming element is provided at the attachment unit as described in item (5), the alarming element (buzzer BZ2 in this embodiment) may be parallel connected to the series-connected contacts 3c and C1 as is done in the rightmost attachment unit AU1 in FIG. 11. According to this, a voltage is not applied to the buzzer BZ2 when the contacts 3c and C1 are closed, and therefore the alarm is not issued from the buzzer BZ2. When at least one of the contacts 3c and C1 is open, a voltage is applied to the buzzer BZ2 from the power source PS via a resistance R2, whereby the alarm is set off from the buzzer BZ2.

Although the present invention has been described and illustrated in detail, it is clearly understood that the same is by way of illustration and example only and is not to be taken by way of limitation, the spirit and the scope of the present invention being limited only by the terms of the appended claims.

What is claimed is:

1. A shoplifting monitoring apparatus comprising:
a casing having an article attachment surface to be attached to an article;
a switch at least partly accommodated in said casing, having a movable piece biased to project outward from said article attachment surface of said casing, and having a contact adapted to become closed when said movable piece is pushed toward an inside of said casing and to become open when said movable piece is projected outward from said casing;
a first conductive member provided at said article attachment surface of said casing;
a second conductive member provided at said article attachment surface of said casing, and remote from said first conductive member;
a conductive film to be provided at said article attachment surface of said casing and to be in contact with each of said first and second conductive members; and
an alarm device; wherein
an electric contact is formed by said conductive film and said first and second conductive members, and
said alarm device issues an alarm when said contact of said switch is open and/or when an electrically connected state between said first and second conductive members is open.

2. The shoplifting monitoring apparatus according to claim 1, further comprising a double-sided adhesive tape to be attached to said article attachment surface of said casing, wherein said conductive film is to be attached to one of surfaces of said double-sided adhesive tape, and said conductive film is to be in contact with each of said first and second conductive members by attaching said double-sided adhesive tape to said article attachment surface of said casing.

3. The shoplifting monitoring apparatus according to claim 1, comprising two or more attachment units each including said casing, said switch, said first conductive member, said second conductive member and said conductive film, wherein said alarm device issues the alarm when said contact of said switch in at least one of said attachment units is open, and/or when the electrically connected state between said first and second conductive members in at least one of said attachment units is open.

4. The shoplifting monitoring apparatus according to claim 2, comprising two or more attachment units each including said casing, said switch, said first conductive member, said second conductive member and said conductive film, wherein said alarm device issues the alarm when said contact of said switch in at least one of said attachment units is open, and/or when the electrically connected state between said first and second conductive members in at least one of said attachment units is open.
